(19) United States
(12) Patent Application Publication
(10) Pub. No.: US 2009/0301365 A1
(43) Pub. Date: Dec. 10, 2009

(54) LAWN SEEDING PATCHING DEVICE

(76) Inventor: Robert Flaherty, Port Jefferson Station, NY (US)

Correspondence Address: Panagiota Betty Tufariello, Esq.;LAW OFFICE OF P.B. TUFARIELLO, P.C., 25 Little Harbor Road, Mt. Sinai, NY, 11766, US

(21) Appl. No.: 12/344,441

(22) Filed: Dec. 26, 2008

Related U.S. Application Data
(60) Provisional application No. 61/008,919, filed on Dec. 26, 2007.

(51) Int. Cl. A01C 7/16

(52) U.S. Cl. 111/8

(57) ABSTRACT

A seeding device for the patching of a lawn comprising a staff-like body having a proximal end, a distal end, walls defining an elongated cavity, such that the staff-like body can act as a tube for the holding and storing of grass seed and a lever. The proximal end terminates into a funnel-like open end covered with a cap by which the elongated cavity is filled with grass seed and capped to prevent the stored grass seed from pouring out of the staff-like body. The distal end is provided with a housing fixedly connected to the staff-like body. The housing comprises a dispensing aperture communicatingly connected to the elongated cavity, a baffle fixedly connected to a cable that is connected to the lever, the baffle further covering and sealing the dispensing aperture, dispersing fins angled and connected to the staff-like body, and tine wheels rotatably connected to and supported by the housing fixedly at the distal end, whereby seed is dispensed by actuating the lever to pull the baffle, which in turn opens the dispensing aperture and allows the seed to flow down, out of the tube, and directed to each of the tine wheels by the angled dispensing fins.

### CLAIM OF PRIORITY

The present non-provisional application hereby claims priority of the earlier filed U.S. Provisional Application No. 61/008,919 by virtue of the fact that the applicant is the inventor of the subject matter for which protection was sought by way of said earlier filed provisional application.

### BACKGROUND OF THE INVENTION

### Field of Invention

The present invention relates to items of lawn improvement. More particularly it relates to an improved tool for lawn seeding and patching.

### BRIEF DESCRIPTION OF THE DRAWINGS

While the specification shall conclude with claims which will particularly point out and distinctly claim the present invention, it is believed that the present invention will be better understood from the following detailed description taken in conjunction with the accompanying drawings in which like numerals represent identical elements and wherein:

FIG. 1 is three-dimensional perspective of the inventive lawn patching and seeding device.

FIG. 2 is a three-dimensional, perspective of the distal end of the inventive lawn patching and seeding device of FIG. 1.

FIG. 3 is a three-dimensional perspective of the distal end of the inventive lawn patching and seeding device of FIG. 2 with the top cover removed to show the inner workings of the device;

FIG. 4 is a larger, three-dimensional, perspective, exploded view of the proximate end of the inventive lawn patching device of FIG. 1;

FIGS. 5 and 6 is a plan side view of the distal end of the inventive lawn patching and seeding device of FIG. 1;

FIG. 7 is the inventive lawn patching device of FIG. 1, exploded to show its individual components.

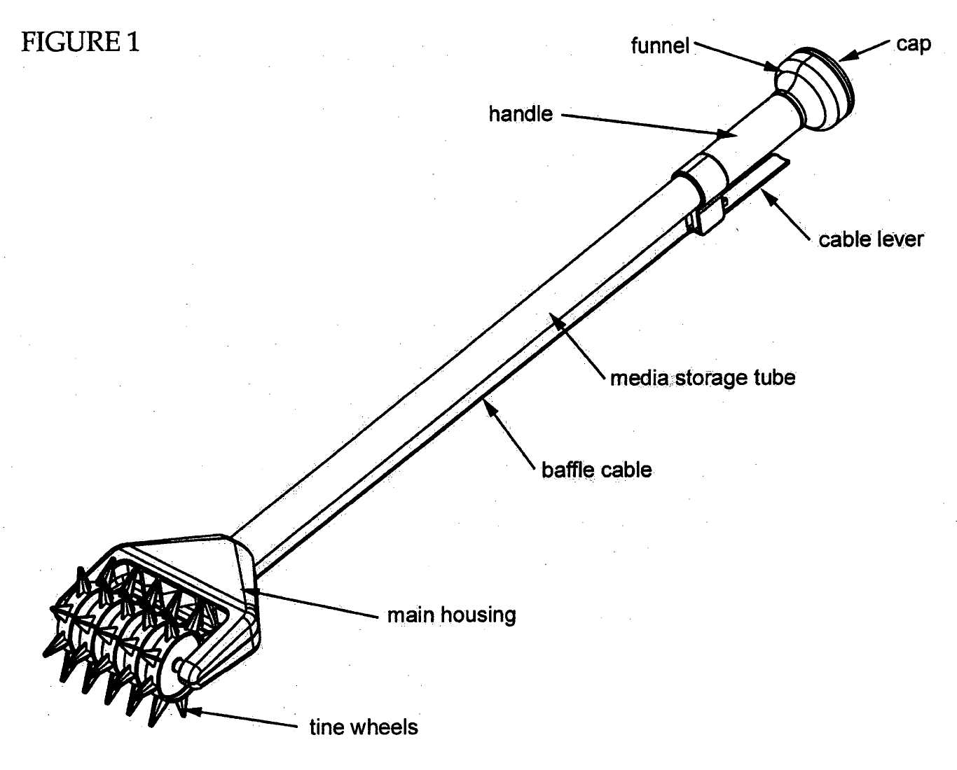

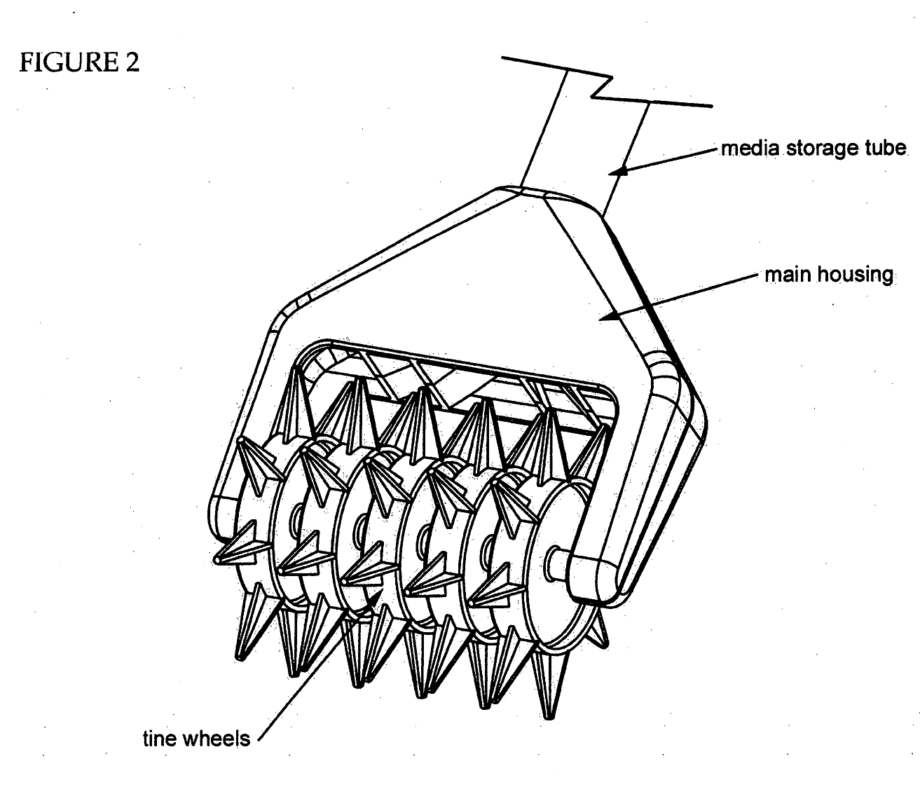

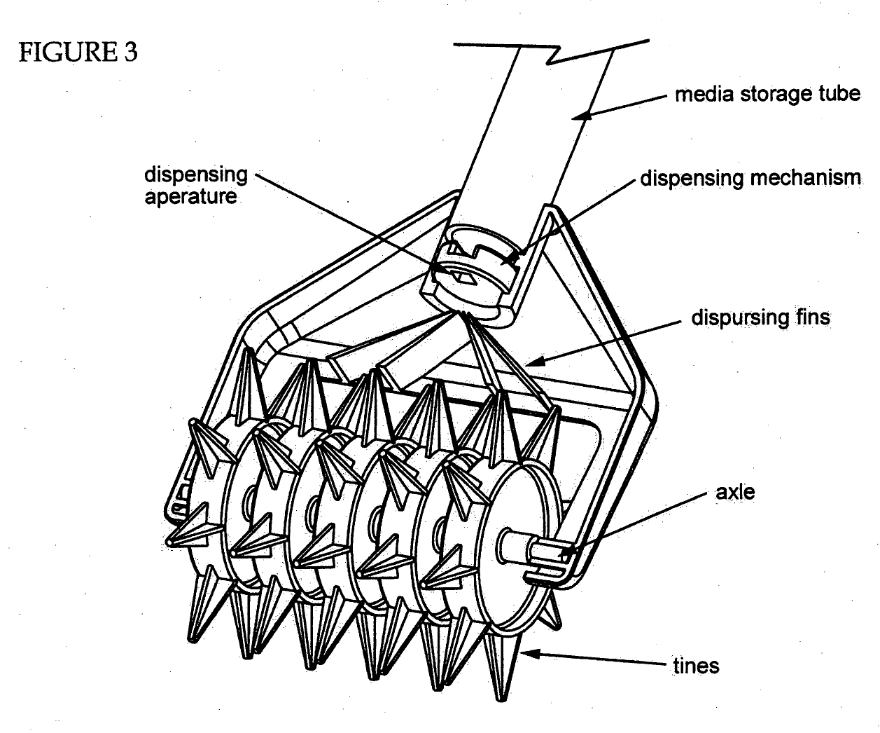

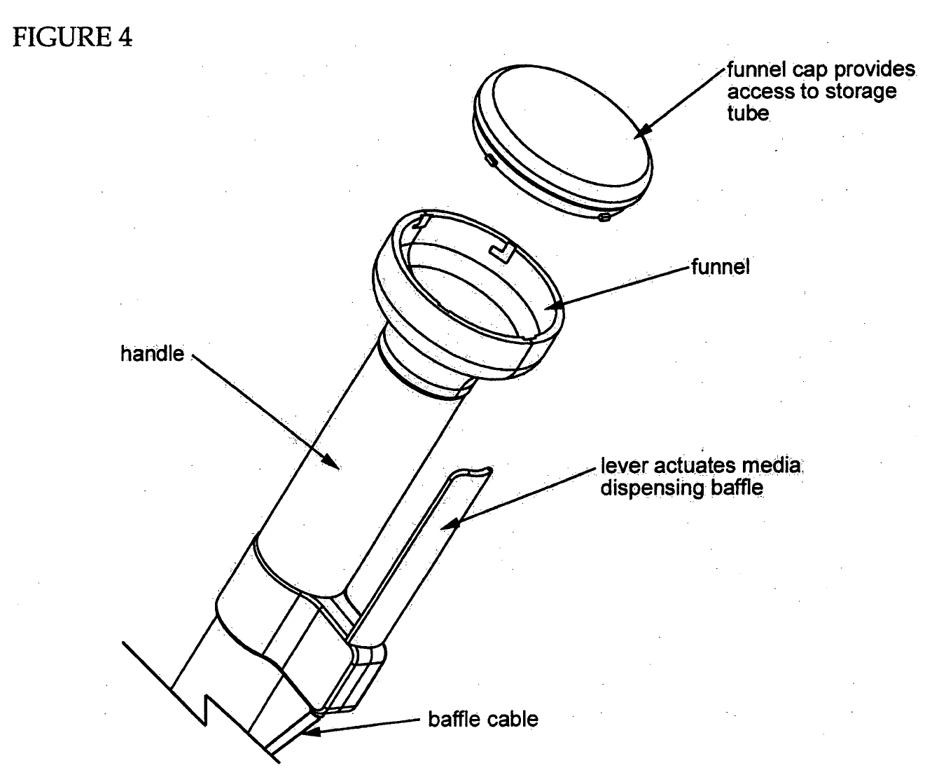

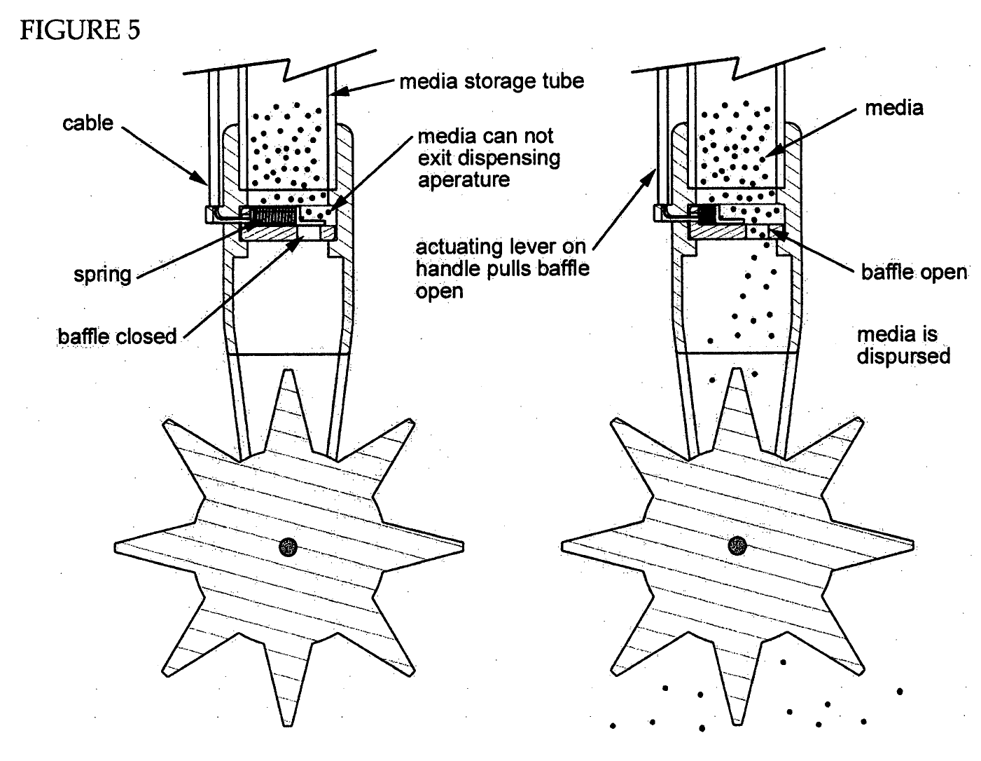

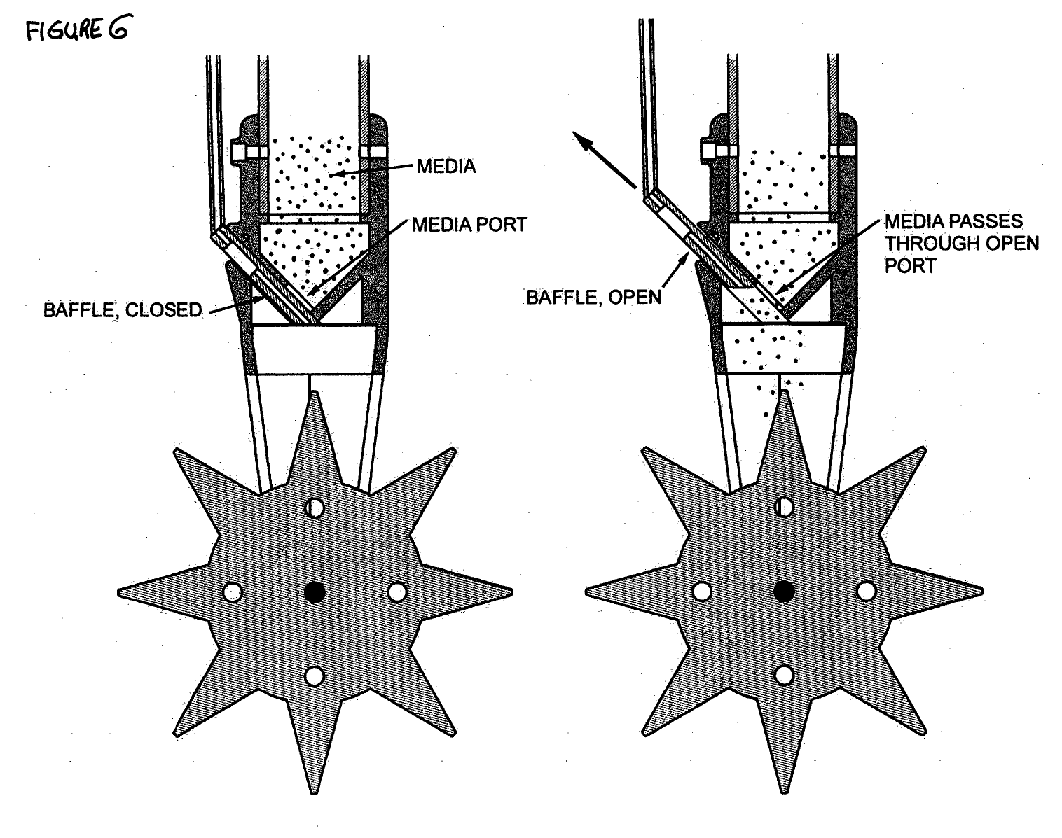

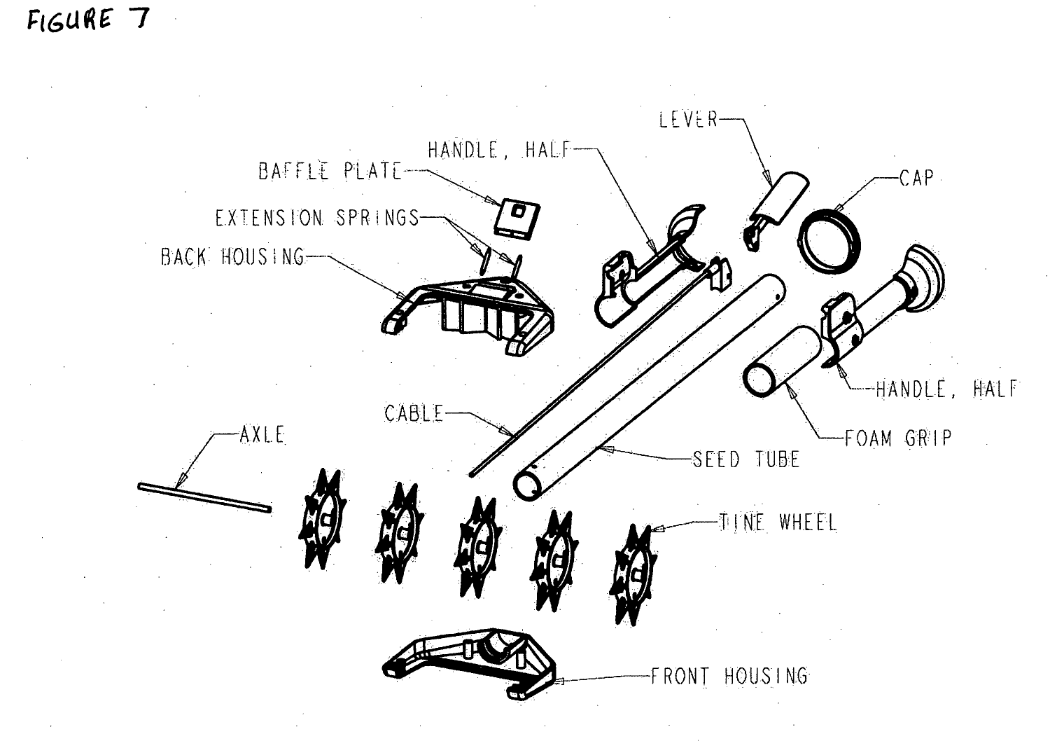

### DETAILED DESCRIPTION OF THE INVENTION

While particular embodiments of the invention have been illustrated and described in detail herein, they are provided by way of illustration only and should not be construed to limit the invention. Since certain changes may be made without departing from the scope of the present invention, it is intended that all matter contained in the above description, or shown in the accompanying drawings be interpreted as illustrative and not in literal sense. Practitioners of the art will realize that the sequence of steps and the embodiments depicted in the figures can be altered without departing from the scope of the present invention and that the illustrations contained herein are singular examples of a multitude of possible depictions of the present invention.

Accordingly, I claim:

1. A lawn seeding patching device comprising:
a. a staff-like body having a proximal end, a distal end, walls defining an elongated cavity, such that said staff-like body can act as a tube for the holding and storing of grass seed and a lever;
said proximal end terminating into a funnel-like open end covered with a cap by which the elongated cavity is filled with grass send and capped to prevent the stored grass seed from pouring out of said staff-like body;
said distal end provided with a housing fixedly connected to said staff-like body and enclosing a dispensing aperture communicatingly connected to said elongated cavity, a baffle fixedly connected to a cable connected to said lever and covering and sealing said dispensing apperture, and dispursing fins angled and connected to said staff-like body; and
b. tine wheels rotatably connected to said housing fixedly connected to said distral end;
whereby seed is dispensed by actuating said lever to pull the baffle, open the dispensing aperture and allow the seed to flow down, out of the tube, and directed to each of the tine wheels by the angled dispensing fins.
